(19) United States
(12) Patent Application Publication
(10) Pub. No.: US 2014/0020665 A1
(43) Pub. Date: Jan. 23, 2014

(54) EXHAUST GAS RECIRCULATION APPARATUS

(71) Applicant: AISAN KOGYO KABUSHIKI KAISHA, Obu-shi (JP)

(72) Inventor: Mamoru YOSHIOKA, Nagoya-shi (JP)

(21) Appl. No.: 13/933,703

(22) Filed: Jul. 2, 2013

(30) Foreign Application Priority Data
Jul. 17, 2012 (JP) 2012-158491

(51) Int. Cl. F02M 25/07

(52) U.S. Cl. CPC F02M 25/0773
USPC 123/568.24

(57) ABSTRACT

An EGR apparatus includes an EGR passage and an EGR valve including a valve seat, valve element, and step motor. In a fully closed state of the EGR valve with the valve element seated on the valve seat, a front-side pressure of the valve element is detected by an air flow meter and a back-side pressure of the valve element is detected by an intake pressure sensor. An ECU calculates a differential pressure between the front-side pressure and the back-side pressure as a front-and-back differential pressure. When the front-and-back differential pressure is smaller than a predetermined reference value, the ECU allows opening of the EGR valve from the fully closed state and allows driving of the step motor. The ECU can also correct the reference value according value according to voltage of a battery that supplies electric power to the step motor.

### CROSS-REFERENCE TO RELATED APPLICATIONS

This application is based upon and claims the benefit of priority from the prior Japanese Patent Application No. 2012-158491 filed on Jul. 17, 2012, the entire contents of which are incorporated herein by reference.

### BACKGROUND OF THE INVENTION

1. Field of the Invention

The present invention relates to an exhaust gas recirculation (EGR) apparatus for an engine to allow part of exhaust gas discharged from an engine to an exhaust passage to flow in an intake passage to recirculate back to the engine.

2. Related Art

Conventionally, a technique of the above type is employed in a vehicle engine, for example. An exhaust gas recirculation (EGR) apparatus is arranged to introduce part of exhaust gas after combustion, which is discharged from a combustion chamber of an engine to an exhaust passage, into an intake passage through an EGR passage so that the exhaust gas is mixed with intake air flowing in the intake passage and flows back to the combustion chamber. EGR gas flowing in an EGR passage is regulated by an EGR valve provided in the EGR passage. This EGR can reduce mainly nitrogen oxide (NOx) in the exhaust gas and improve fuel consumption during a partial load operation of the engine.

Exhaust gas from the engine contains no oxygen or is in an oxygen lean state. Thus, when part of the exhaust gas is mixed with the intake air by EGR, the oxygen concentration of the intake air decreases. In a combustion chamber, therefore, fuel burns in a low oxygen concentration. Thus, a peak temperature during combustion decreases, thereby restraining the occurrence of NOx. In a gasoline engine, even when the content of oxygen in intake air is not increased by EGR and a throttle valve is closed to some degree, it is possible to reduce pumping loss of the engine.

Herein, recently, it is conceivable to perform EGR in the entire operating region of the engine in order to further improve fuel consumption. Realization of high EGR is thus demanded. To realize the high EGR, it is necessary for conventional arts to increase the internal diameter of an EGR passage or increase the opening area of a flow passage provided by a valve element and a valve seat of an EGR valve. That is, an EGR valve has to be increased in size.

Meanwhile, as the EGR valve, there is a valve configured so that a valve element is opened and closed by an actuator such as a motor to a fine or small opening degree or position. An EGR device including this type of EGR valve is disclosed in e.g. JP 2004-36413A. This device may cause a problem that, when the EGR valve is to be opened from a fully closed state in an engine provided with a supercharger, if a difference in pressure (differential pressure) between pressure on an exhaust upstream side (an exhaust side) of the valve element and pressure on an exhaust downstream side (an intake side) of the valve element becomes larger, an excessive amount of EGR gas may flow in the EGR passage. To restrain such an excessive flow of EGR gas, therefore, when the EGR valve is to be opened from the fully closed state to a target opening degree, the EGR valve is opened once to a smaller opening degree than the target opening degree and then further opened to the target opening degree.

### SUMMARY OF INVENTION

### Problems to be Solved by the Invention

However, in the apparatus disclosed in JP 2004-36413A, when the EGR valve is increased in size for the high EGR, the differential pressure between the pressure on the exhaust side of the valve element and the pressure on the intake side of the valve element tends to increase. Thus, to open the EGR valve once from the fully closed state to the small opening degree region, it is necessary to hold the valve element by a drive force enough to overcome the increased differential pressure. As a result, the actuator is requested to generate a large drive force and hence has to be increased in size and in performance. This results in problems of deterioration in mountability of the EGR valve on a vehicle and cost increase of the EGR apparatus.

The present invention has been made in view of the circumstances and has a purpose to provide an exhaust gas recirculation (EGR) apparatus for an engine, capable of preventing deterioration in mountability of an EGR valve on a vehicle and cost increase in an EGR apparatus without increasing the size and the performance of an actuator.

### Means of Solving the Problems

To achieve the above purpose, one aspect of the invention provides an exhaust gas recirculation apparatus including: an exhaust gas recirculation passage to allow part of exhaust gas discharged from a combustion chamber of an engine to an exhaust passage to flow in an intake passage and recirculate back to the combustion chamber; and an exhaust gas recirculation valve provided in the exhaust gas recirculation passage to regulate an exhaust flow rate in the exhaust gas recirculation passage, the exhaust gas recirculation valve including a valve seat, a valve element provided to be seatable on the valve seat, and an actuator to drive the valve element, wherein the apparatus further includes: a front-side pressure detection unit to detect pressure of exhaust gas on an upstream side of the valve element as a front-side pressure when the exhaust gas recirculation valve is in a fully closed state in which the valve element is seated on the valve seat; a back-side pressure detection unit to detect pressure of exhaust gas on a downstream side of the valve element as a back-side pressure when the exhaust gas recirculation valve is in the fully closed state; and a valve-opening control unit configured to calculate a differential pressure between the front-side pressure and the back-side pressure as a front-and-back differential pressure, and allow opening of the exhaust gas recirculation valve from the fully closed state and allow driving of the actuator when the front-and-back differential pressure is smaller than a predetermined reference value.

Another aspect of the invention provides an exhaust gas recirculation apparatus including: an exhaust gas recirculation passage to allow part of exhaust gas discharged from a combustion chamber of an engine to an exhaust passage to flow in an intake passage and recirculate back to the combustion chamber; and an exhaust gas recirculation valve provided in the exhaust gas recirculation passage to regulate an exhaust flow rate in the exhaust gas recirculation passage, the exhaust gas recirculation valve including a valve seat, a valve element provided to be seatable on the valve seat, and a step motor to drive the valve element, wherein the apparatus further includes: an energization control unit configured to control and energize the step motor at a predetermined drive frequency to open the exhaust gas recirculation valve; a front-side pressure detection unit to detect pressure of exhaust gas on an upstream side of the valve element as a front-side pressure when the exhaust gas recirculation valve is in a fully closed state in which the valve element is seated on the valve seat; and a back-side pressure detection unit to detect pressure of exhaust gas on a downstream side of the valve element as a back-side pressure when the exhaust gas recirculation valve is in the fully closed state; wherein the energization control unit is configured to calculate a differential pressure between the front-side pressure and the back-side pressure as a front-and-back differential pressure and control to energize the step motor at a drive frequency lower than a normal value in at least an initial stage to open the exhaust gas recirculation valve from the fully closed state when the front-and-back differential pressure is larger than a predetermined reference value.

### Effects of the Invention

According to the invention, it is not necessary to increase the size and the performance of an actuator (a step motor) and it is possible to prevent deterioration in mountability of an EGR valve on a vehicle and cost increase of an EGR apparatus.

### BRIEF DESCRIPTION OF THE DRAWINGS

FIG. 1 is a schematic configuration view showing a supercharger-equipped engine system including an exhaust gas recirculation (EGR) apparatus for an engine in a first embodiment;

FIG. 2 is a cross sectional view schematically showing an EGR valve in the first embodiment;

FIG. 3 is a flowchart showing one example of processing details of an EGR-valve front-and-back differential pressure calculation routine in the first embodiment;

FIG. 4 is a flowchart showing one example of processing details of an EGR-valve opening control routine in the first embodiment;

FIG. 5 is a map set in advance to be referred to for calculation of exhaust pressure in the first embodiment;

FIG. 6 is a graph showing a relationship between magnitude of the EGR-valve front-and-back differential pressure and ON/OFF of EGR in the first embodiment;

FIG. 7 is a flowchart showing one example of processing details of an EGR-valve opening control routine in a second embodiment;

FIG. 8 is a map set in advance to be referred to for calculation of a reference value in the second embodiment;

FIG. 9 is a flowchart showing one example of processing details of an EGR-valve opening control routine in a third embodiment;

FIG. 10 is a map set in advance to be referred to for calculation of a valve-opening drive frequency in the third embodiment; and

FIG. 11 is a schematic configuration view showing a supercharger-equipped engine system including an exhaust gas recirculation (EGR) apparatus for an engine in a fourth embodiment.

### DESCRIPTION OF EMBODIMENTS

### First Embodiment

A detailed description of a preferred first embodiment of an exhaust gas recirculation apparatus for an engine embodying the present invention will now be given referring to the accompanying drawings.

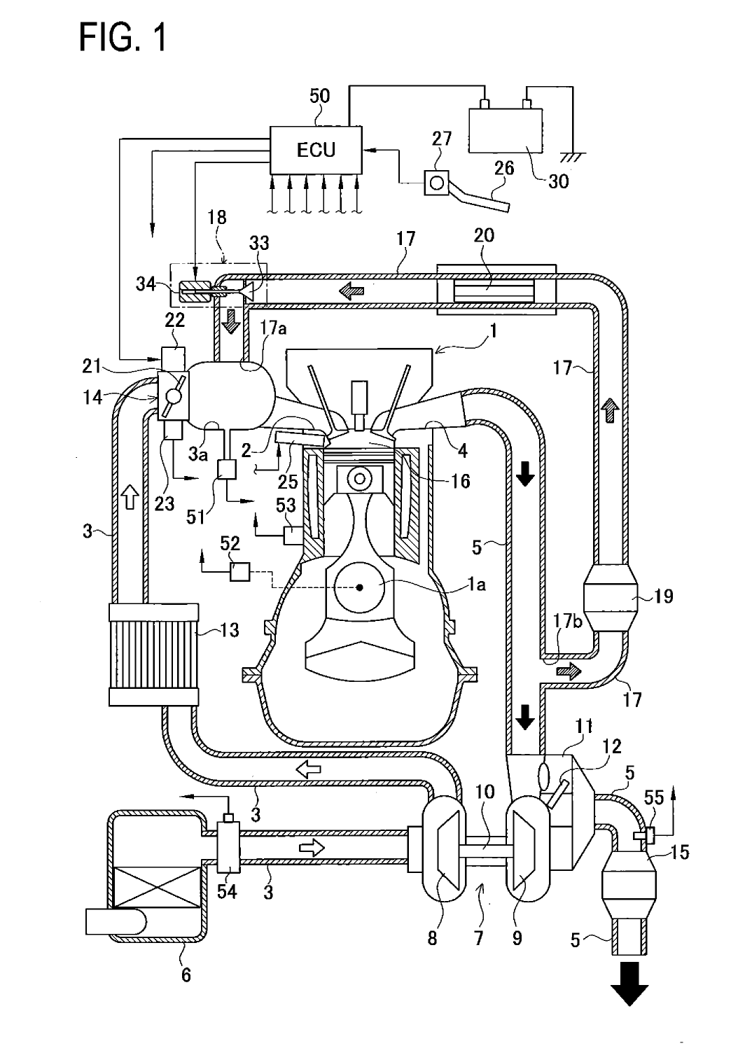

FIG. 1 is a schematic configuration view of a supercharger-equipped engine system including an exhaust gas recirculation (EGR) apparatus for an engine in the present embodiment. This engine system includes a reciprocating-type engine 1. This engine 1 has an intake port 2 connected to an intake passage 3 and an exhaust port 4 connected to an exhaust passage 5. An air cleaner 6 is provided at an inlet of the intake passage 3. In the intake passage 3 downstream from the air cleaner 6, a supercharger 7 is placed in a position between a portion of the intake passage 3 and a portion of the exhaust passage 5 to increase the pressure of intake air in the intake passage 3.

The supercharger 7 includes a compressor 8 placed in the intake passage 3, a turbine 9 placed in the exhaust passage 5, and a rotary shaft 10 connecting the compressor 8 and the turbine 9 so that they are integrally rotatable. The supercharger 7 is configured to rotate the turbine 9 with exhaust gas flowing in the exhaust passage 5 and integrally rotate the compressor 8 through the rotary shaft 10 in order to increase the pressure of intake air in the intake passage 3, that is, carry out supercharging.

In the exhaust passage 5, adjacent to the supercharger 7, an exhaust bypass passage 11 is provided by detouring around the turbine 9. In this exhaust bypass passage 11, a waste gate valve 12 is placed. This waste gate valve 12 regulates exhaust gas allowed to flow in the exhaust bypass passage 11. Thus, a flow rate of exhaust gas to be supplied to the turbine 9 is regulated, thereby controlling the rotary speeds of the turbine 9 and the compressor 8, and adjusting supercharging pressure of the supercharger 7.

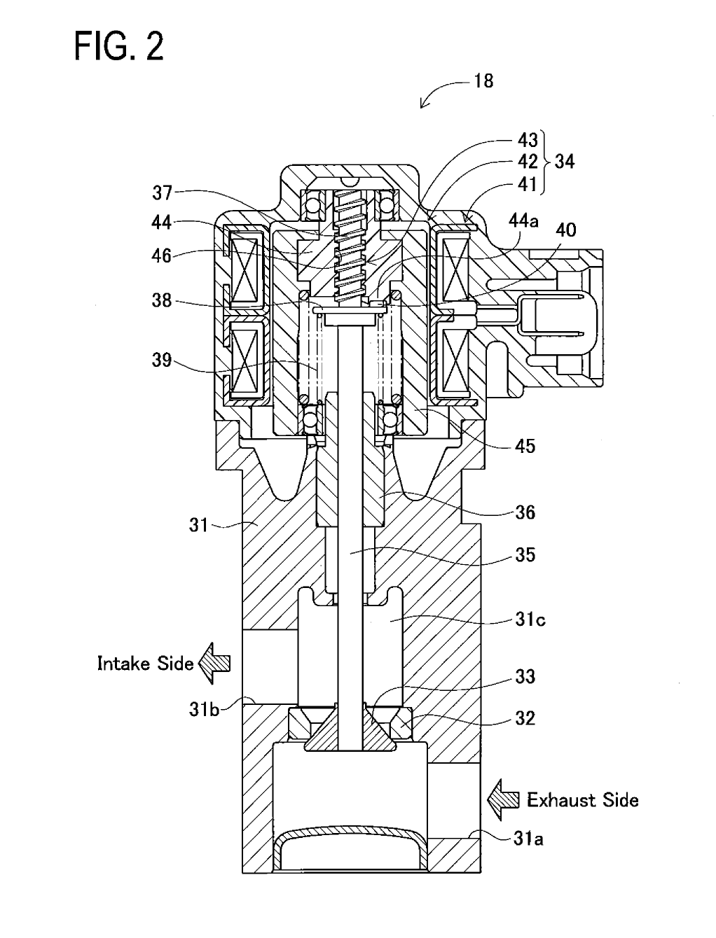

In the intake passage 3, an intercooler 13 is provided between the compressor 8 of the supercharger 7 and the engine 1. This intercooler 13 serves to cool intake air having the pressure increased by the compressor 8 and hence a high temperature, down to an appropriate temperature. A surge tank 3a is provided in the intake passage 3 between the intercooler 13 and the engine 1. Further, an electronic throttle device 14 that is an electrically-operated throttle valve is placed downstream from the intercooler 13 but upstream from the surge tank 3a. This throttle device 14 includes a butterfly-shaped throttle valve 21 placed in the intake passage 3, a step motor 22 to drive the throttle valve 21 to open and close, and a throttle sensor 23 to detect an opening degree (a throttle opening degree) TA of the throttle valve 21. This throttle device 14 is configured so that the throttle valve 21 is driven by the step motor 22 to open and close according to operation of an accelerator pedal 26 by a driver to adjust the opening degree. The configuration of this throttle device 14 can be provided by for example a basic configuration of a “throttle device” disclosed in JP-A-2011-252482, FIGS. 1 and 2. In the exhaust passage 5 downstream from the turbine 9, a catalytic converter 15 is provided as an exhaust catalyst to clean exhaust gas.

The engine 1 is further provided with an injector 25 to inject and supply fuel into a combustion chamber 16. The injector 25 is configured to be supplied with the fuel from a fuel tank (not shown).

In the present embodiment, the EGR apparatus to enable high EGR includes an exhaust gas recirculation (EGR) passage 17 allowing part of exhaust gas discharged from the combustion chamber 16 of the engine 1 to the exhaust passage 5 to flow in the intake passage 3 and recirculate back to the combustion chamber 16, and an exhaust gas recirculation (EGR) valve 18 placed in the EGR passage 17 to regulate an exhaust gas flow rate (EGR flow rate) in the EGR passage 17. The EGR passage 17 is provided to extend between the exhaust passage 5 upstream from the turbine 9 and the surge tank 3a. Specifically, an outlet 17a of the EGR passage 17 is connected to the surge tank 3a on a downstream side from the throttle valve 21 in order to allow a part of exhaust gas flowing in the exhaust passage 5 to flow as EGR gas into the intake passage 3 and recirculate to the combustion chamber 16. An inlet 17b of the EGR passage 17 is connected to the exhaust passage 5 upstream from the turbine 9.

In the vicinity of the inlet 17b of the EGR passage 17, an EGR catalytic converter 19 is provided to clean EGR gas. In the EGR passage 17 downstream from this EGR catalytic converter 19, an EGR cooler 20 is provided to cool EGR gas flowing in the EGR passage 17. In the present embodiment, the EGR valve 18 is located in the EGR passage 17 downstream from the EGR cooler 20.

FIG. 2 is a cross sectional view showing a schematic configuration of the EGR valve 18. As shown in FIG. 2, the EGR valve 18 is configured as a poppet valve and a motor-operated valve. Specifically, the EGR valve 18 is provided with a housing 31, a valve seat 32 provided in the housing 31, a valve element 33 configured to seat on and move apart from the valve seat 32 inside the housing 31, and a step motor 34 to perform stroke movement of the valve element 33. The step motor 34 is one example of an actuator of the present invention. The housing 31 includes an inlet 31a through which EGR gas flows from the side of the exhaust passage 5 (an exhaust side) into the EGR valve 18, an outlet 31b through which exhaust gas flows out of the valve 18 to the side of the intake passage 3 (an intake side), and a communication passage 31c connecting the inlet 31a and the outlet 31b. The valve seat 32 is provided at the midpoint of the communication passage 31c. Herein, in the EGR passage 17, pulsation of the exhaust gas pressure of the engine 1, generated in the exhaust passage 5, acts on the inlet 17b, while pulsation of the intake pressure of the engine 1, generated in the surge tank 3a, acts on the outlet 17a. On the valve element 33 of the EGR valve 18, accordingly, the pulsation of the exhaust gas pressure on an upstream side of the EGR passage 17 acts via the inlet 31a, while the pulsation of intake pressure on a downstream side of the EGR passage 17 acts via the outlet 31b.

The step motor 34 includes an output shaft 35 arranged to reciprocate in a straight line (stroke movement). The valve element 33 is fixed at a leading end of the output shaft 35. This output shaft 35 is supported to be able to perform stroke movement through a bearing 36 provided in the housing 31. The output shaft 35 is formed, in its upper part, with a male screw section 37. The output shaft 35 is further formed, in its middle part (near a lower end of the male screw section 37), with a spring retainer 38. This spring retainer 38 has a lower surface serving as a rest for holding a compression spring 39 and an upper surface formed with a stopper 40.

The valve element 33 has a conical shape and is configured to come into or out of contact with the valve seat 32. The valve element 33 is urged toward the step motor 34 by the compression spring 39 placed between the spring retainer 38 and the housing 31, that is, in a valve closing direction to seat on the valve seat 32. When the valve element 33 in a closed state is stroke-moved by the output shaft 35 of the step motor 34 against the urging force of the compression spring 39, the valve element 33 is moved apart from the valve seat 32 to a valve open state. For valve opening, specifically, the valve element 33 is moved toward the upstream side (exhaust side) of the EGR passage 17. As above, the EGR valve 18 is configured to open by moving the valve element 33 from the closed state in which the valve element 33 seats on the valve seat 32 toward the upstream side of the EGR passage 17 against the exhaust gas pressure or intake pressure of the engine 1. On the other hand, the valve element 33 is stroke-moved from the open state in the urging direction of the compression spring 39 by the output shaft 35 of the step motor 34, so that the valve element 33 comes near the valve seat 32 and into the closed state. For valve closing, specifically, the valve element 33 is moved toward the downstream side (intake side) of the EGR passage 17.

By stroke-moving the output shaft 35 of the step motor 34, the opening degree of the valve element 33 with respect to the valve seat 32 is adjusted. The output shaft 35 of the EGR valve 18 is arranged to be stroke-movable in a range from the fully closed state where the valve element 33 seats on the valve seat 32 to the fully opened state where the valve element 33 is most apart from the valve seat 32. To achieve high EGR, in the present embodiment, the area of a passage opening in the valve seat 32 is set larger than that in the conventional art. Accordingly, the valve element 33 is designed to be larger in size than that in the conventional art.

The step motor 34 includes a coil 41, a magnet rotor 42, and a converting mechanism 43. The step motor 34 is configured so that the coil 41 is excited or energized by currents to rotate the magnet rotor 42 by a predetermined number of motor steps Mst(n), and the converting mechanism 43 converts the rotational movement of the magnet rotor 42 into the stroke movement of the output shaft 35, thereby stroke-moving the valve element 33.

The magnet rotor 42 includes a rotor body 44 made of resin and a ring-shaped plastic magnet 45. The rotor body 44 is formed, in its center, with a female screw section 46 threadedly engaging with the male screw section 37 of the output shaft 35. When the rotor body 44 is rotated with its female screw section 46 threadedly engaging with the male screw section 37 of the output shaft 35, the rotational movement of the rotor body 44 is converted to stroke movement of the output shaft 35. Herein, the male screw section 37 and the female screw section 46 constitute the aforementioned converting mechanism 43. The rotor body 44 is formed, at its bottom, with a contact portion 44a against which the stopper 40 of the spring retainer 38 abuts. When the EGR valve 18 is fully closed, the end face of the stopper 40 comes into surface contact with the end face of the contact portion 44a, thereby restricting the initial position of the output shaft 35.

In the present embodiment, the number of motor steps Mst(n) of the step motor 34 is changed in a stepwise manner to finely adjust the opening degree of the valve element 33 of the EGR valve 18 in stages in a range between full close and full open.

In the present embodiment, for separately executing fuel injection control, intake amount control, EGR control, and other controls, the injector 25, the step motor 22 of the electronic throttle device 14, and the step motor 34 of the EGR valve 18 are each controlled by an electronic control unit (ECU) 50 according to the operating condition of the engine 1. The ECU 50 includes a central processing unit (CPU), various memories that store a predetermined control program and others or temporarily store calculation results and others of the CPU, and an external input circuit and an external output circuit connected to each of them. The ECU 50 is one example of a valve-opening control unit of the invention. To the external output circuit, there are connected the injector 25 and each of the step motors 22 and 34. To the external input circuit, there are connected the throttle sensor 23 and various sensors 27 and 51-55 which are one example of an operating condition detection unit to detect the operating condition of the engine 1 and transmit various engine signals to the external input circuit. The ECU 50 is also arranged to output a predetermined command signal to the step motor 34 in order to control the step motor 34.

The various sensors provided in the present embodiment include the accelerator sensor 27, the intake pressure sensor 51, the rotation speed sensor 52, the water temperature sensor 53, the air flow meter 54, and the air-fuel ratio sensor 55 as well as the throttle sensor 23. The accelerator sensor 27 detects an accelerator opening degree ACC corresponding to an operation amount of the accelerator pedal 26. This accelerator pedal 26 is one example of an operating unit to control the operation of the engine 1. The intake pressure sensor 51 detects intake pressure PM in the surge tank 3a. That is, the intake pressure sensor 51 is one example of a back-side pressure detection unit of the invention to detect, as a back-side pressure, the pressure of EGR gas on the downstream side of the valve element 33 of the EGR valve 18 when the valve element 33 is seated on the valve seat 32, that is, placed in the fully closed state, as mentioned later. The rotation speed sensor 52 detects the rotation angle (crank angle) of the crank shaft 1a of the engine 1 and also detects changes of the crank angle as the rotation speed (engine rotation speed) NE of the engine 1. The water temperature sensor 53 detects the cooling water temperature THW of the engine 1. Specifically, the water temperature sensor 53 is one example of a temperature-state detection unit of the invention to detect the cooling water temperature THW representing the temperature state of the engine 1. The air flow meter 54 detects an intake amount Ga of intake air flowing in the intake passage 3 directly downstream of the air cleaner 6. The air flow meter 54 and the ECU 50 constitute one example of a front-side pressure detection unit of the invention to detect the pressure of EGR gas on the upstream side of the valve element 33 as the front-side pressure while the valve element 33 is in the fully closed state as mentioned later. The air-fuel ratio sensor 55 is placed in the exhaust passage 5 directly upstream of the catalytic convertor 15 to detect an air-fuel ratio A/F in the exhaust gas.

The ECU 50 is connected to a battery 30. The battery 30 is also connected to various devices such as the step motor 34 of the EGR valve 18 to supply electric power thererto.

In the present embodiment, the ECU 50 is arranged to control the EGR valve 18 in order to control EGR according to the operating condition of the engine 1 in the entire operating region of the engine 1. On the other hand, during deceleration of the engine 1 and deceleration fuel cutoff in which fuel supply to the engine 1 is being cut off, the ECU 50 controls the EGR valve 18 to fully close to shut off the flow of EGR. During the deceleration fuel cutoff, furthermore, the ECU 50 controls the EGR valve 18 to execute various controls which will be mentioned later under a predetermined condition.

Herein, when the size of the EGR valve 18 is increased for high EGR, a differential pressure between the pressure of EGR gas on the upstream side (the exhaust side) of the valve element 3 of the EGR valve 18 and the pressure of EGR gas on the downstream side (the intake side) of the valve element 33 tends to increase. Accordingly, to open the EGR valve 18 from the fully closed state, it is necessary to open the valve element 33 by a drive force required to overcome the above differential pressure. In the present embodiment, therefore, when the EGR valve 18 is to be opened from the fully closed state in consideration of the differential pressure increased due to the use of the EGR valve 18 provided with the step motor 34 similar to the conventional type, the ECU 50 is configured to execute the following EGR valve opening control.

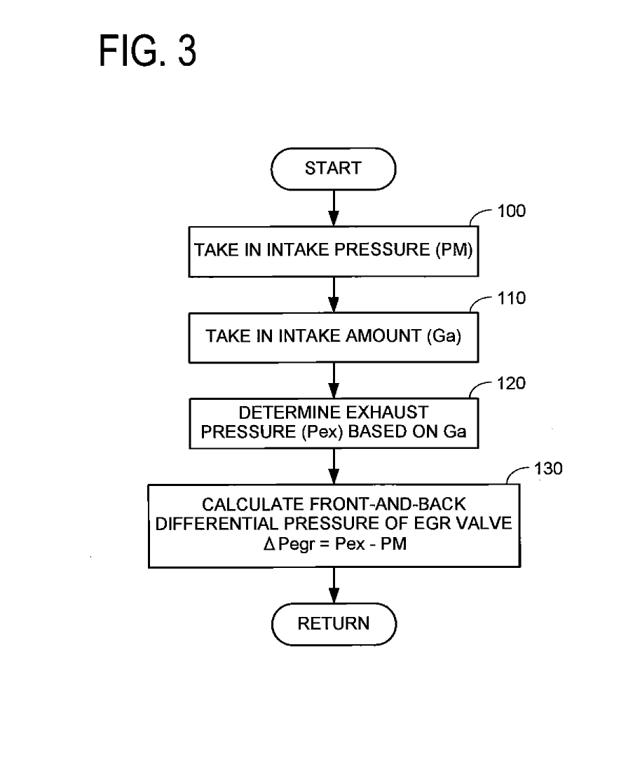

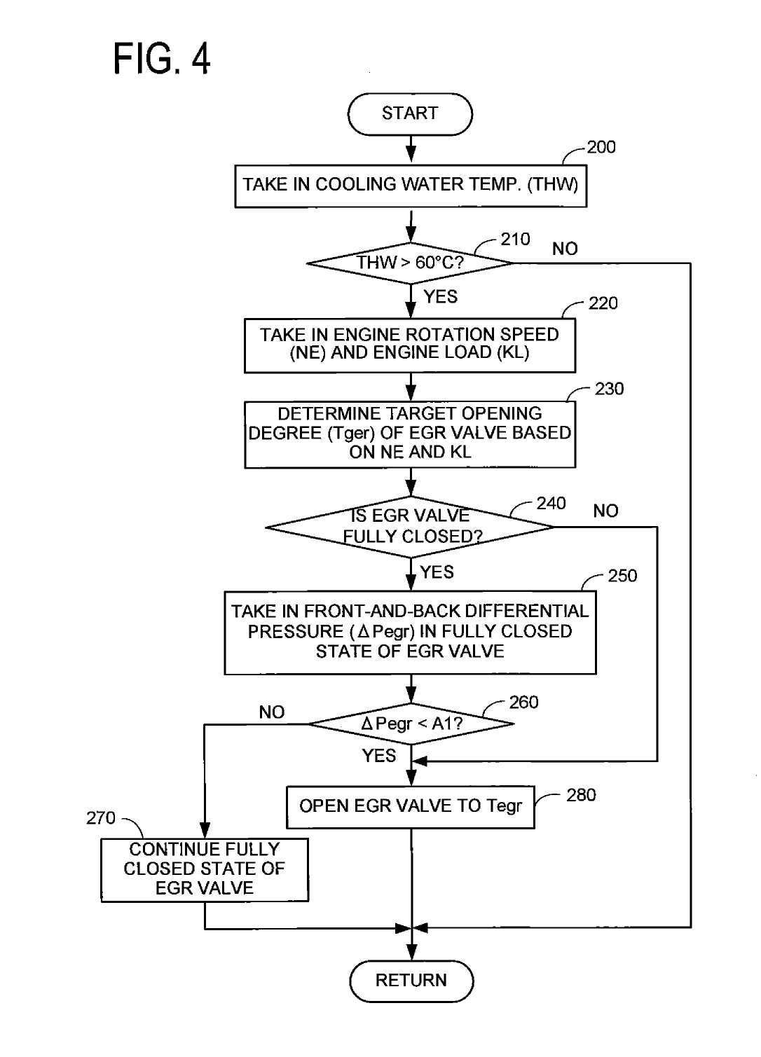

FIG. 3 is a flowchart showing one example of processing details of a routine of EGR-valve front-and-back differential pressure calculation to be executed by the ECU 50. Herein, the EGR-valve front-and-back differential pressure means a differential pressure between the pressure of EGR gas on the upstream side (front side) of the valve element 33 of the EGR valve 18 and the pressure of EGR gas on the downstream side (back side) of the valve element 33 while the valve element 33 is seated on the valve seat 32, that is, located in the fully closed state. FIG. 4 is a flowchart showing one example of processing details of a routine of EGR-valve opening control to be executed by the ECU 50.

When a processing shifts to the routine in FIG. 3, in Step 100, the ECU 50 first takes in an intake pressure PM based on a detection value of the intake sensor 51. Herein, the intake pressure PM corresponds to the pressure of EGR gas on the downstream side (the back side) of the valve element 33 of the EGR valve 18.

In Step 110, the ECU 50 takes in an intake amount Ga based on a measurement value of the air flow meter 54.

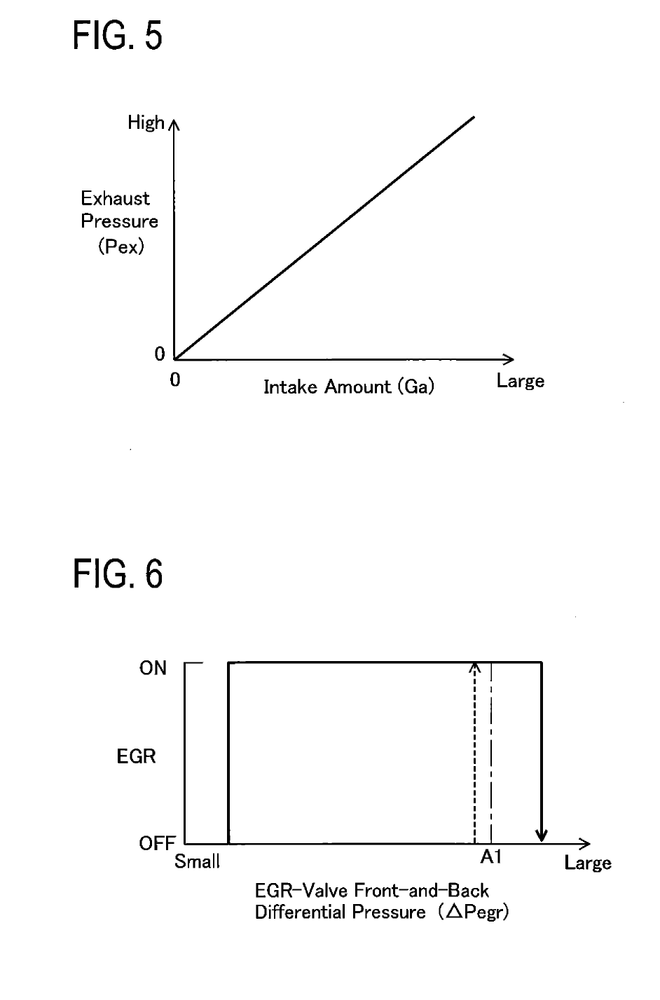

In Step 120, the ECU 50 calculates an exhaust pressure Pex based on the intake amount Ga. Herein, the exhaust pressure Pex corresponds to the pressure of EGR gas on the upstream side (the front side) of the valve element 33 of the EGR valve 18. For example, the ECU 50 calculates the exhaust pressure Pex by referring to a map set in advance as shown in FIG. 5. In this map, the exhaust pressure Pex is set to linearly increase as the intake amount Ga increases.

In Step 130, subsequently, the ECU 50 calculates a front-and-back differential pressure ΔPegr of the EGR valve 18 by subtracting the intake pressure PM from the exhaust pressure Pex and then returns the processing to Step 100. The ECU 50 temporarily stores the calculated front-and-back differential pressure ΔPegr in the memory.

According to the processing of the above EGR-valve front-and-back differential pressure calculation routine, the ECU 50 is arranged to calculate the front-and-back differential pressure ΔPegr of the valve element 33 of the EGR valve 18 at each predetermined processing cycle during operation of the engine 1.

On the other hand, when the processing is shifted to the routine of FIG. 4, in Step 200, the ECU 50 first takes in a cooling water temperature THW based on a detection value of the water temperature sensor 53.

In Step 210, the ECU 50 judges whether or not the cooling water temperature THW is higher than “60° C.”. If NO in this Step 210, the ECU 50 returns the processing to Step 200. If YES in Step 210, the ECU 50 judges that the engine 1 is in a warm-up state and advances the processing to Step 220.

In Step 220, the ECU 50 then takes in an engine rotation speed NE and an engine load KL. Herein, the ECU 50 can determine the engine load KL from a relationship between the engine rotation speed NE and the intake amount Ga or the intake pressure PM.

In Step 230, subsequently, the ECU 50 determines a target opening degree Tegr of the EGR valve 18 based on the engine rotation speed NE and the engine load KL. The ECU 50 can execute this processing by referring to a target opening degree map (not shown) set in advance.

In Step 240, the ECU 50 judges whether or not the EGR valve 18 is in the full closed state. The ECU 50 can make this judgment based on the number of motor steps Mst which is a command value to the step motor 34. If NO in this Step 240, the ECU 50 skips to the processing in Step 280. If YES in Step 240, on the other hand, the ECU 50 shifts the processing to Step 250.

In Step 250, the ECU 50 takes in a front-and-back differential pressure ΔPegr of the EGR valve 18 in the fully closed state. This front-and-back differential pressure ΔPegr is a value calculated in the routine in FIG. 3.

In Step 260, the ECU 50 judges whether or not the front-and-back differential pressure ΔPegr is smaller than a predetermined reference value A1. This reference value A1 corresponds to for example a value of “10% to 30%” of the front-and-back differential pressure ΔPegr estimated at the time of high-rotation and high-load of the engine 1. If NO in Step 260, the ECU 50 continues the fully closed state of the EGR valve 18 in Step 270 and then returns the processing to Step 200. If YES in Step 260, the ECU 50 shifts the processing to Step 280.

In Step 280 following Step 240 or 260, the ECU 50 opens the EGR valve 18 to the target opening degree Tegr and returns the processing to Step 200.

According to the above EGR valve opening control routine, the ECU 50 calculates the front-and-back differential pressure between the front-side pressure and the back-side pressure of the valve element 33 of the EGR valve 18 as the front-and-back differential pressure ΔPegr, and allows the EGR valve 18 to open from the fully closed state based on the front-and-back differential pressure ΔPegr and allows driving of the step motor 34. To be concrete, as shown in FIG. 6, the ECU 50 allows the EGR valve 18 to open from the fully closed state when the front-and-back differential pressure ΔPegr is smaller than the predetermined reference value A1 and allows driving of the step motor 34. On the other hand, when the front-and-back differential pressure ΔPegr is not smaller than the predetermined reference value A1, as shown in FIG. 6, the ECU 50 inhibits the EGR valve 18 from opening from the fully closed state and inhibits the driving of the step motor 34. FIG. 6 is a graph showing a relationship between the magnitude of the EGR valve front-and-back differential pressure ΔPegr and ON/OFF of EGR.

According to the EGR apparatus for an engine in the present embodiment described above, part of exhaust gas discharged from the combustion chamber 16 of the engine 1 to the exhaust passage 5 is allowed to flow in the intake passage 3 through the EGR passage 17 and recirculate back to the combustion chamber 16. The EGR flow rate in the EGR passage 17 is regulated by control of the EGR valve 18. In the EGR valve 18, the step motor 34 is controlled to drive the valve element 33 to thereby adjust the position of the valve element 33 with respect to the valve seat 32, that is, the EGR opening degree. Herein, while the EGR valve 18 is in the fully closed state, the pressure of EGR gas (the exhaust pressure Pex) acting on the upstream side of the valve element 33 is detected as the front-side pressure by the air flow meter 54 and the ECU 50 and the pressure of EGR gas (the intake pressure PM) acting on the downstream side of the valve element 33 is detected as the back-side pressure by the intake pressure sensor 51. The ECU 50 calculates the differential pressure between the front-side pressure (the exhaust pressure Pex) and the back-side pressure (the intake pressure PM) as the front-and-back differential pressure ΔPegr. When this front-and-back differential pressure ΔPegr is smaller than the predetermined reference value A1, the EGR valve 18 is allowed to open from the fully closed state and the step motor 34 is allowed to drive. On the other hand, when the front-and-back differential pressure ΔPegr is not smaller than the predetermined reference value A1, the EGR valve 18 is inhibited from opening from the fully closed state and the step motor 34 is inhibited from driving, so that the EGR valve 18 continues to be in the fully closed state. Accordingly, when the front-and-back differential pressure ΔPegr is smaller than the predetermined reference value A1 and a request to open the EGR valve 18 is given, the step motor 34 is driven with a relatively small force to drive the valve element 33, thereby opening the EGR valve 18 from the fully closed state. Consequently, a large drive force of the step motor 34 is not required and the step motor 34 of the conventional type can be used without increasing in size and in performance. This can prevent deterioration in mountability of the EGR valve 18 on a vehicle and cost increase of the EGR apparatus.

### Second Embodiment

A second embodiment of an exhaust gas recirculation for an engine according to the invention will be described below referring to the accompanied drawings.

In the following explanation, similar or identical parts to those in the first embodiment are assigned the same reference signs and their details are not repeated. The following explanation is thus given with a focus on differences from the first embodiment.

This second embodiment differs from the first embodiment in the processing details of the EGR valve opening control routine. FM 7 is a flowchart showing one example of the processing details of the EGR valve opening control routine to be executed by the ECU 50 in the present embodiment.

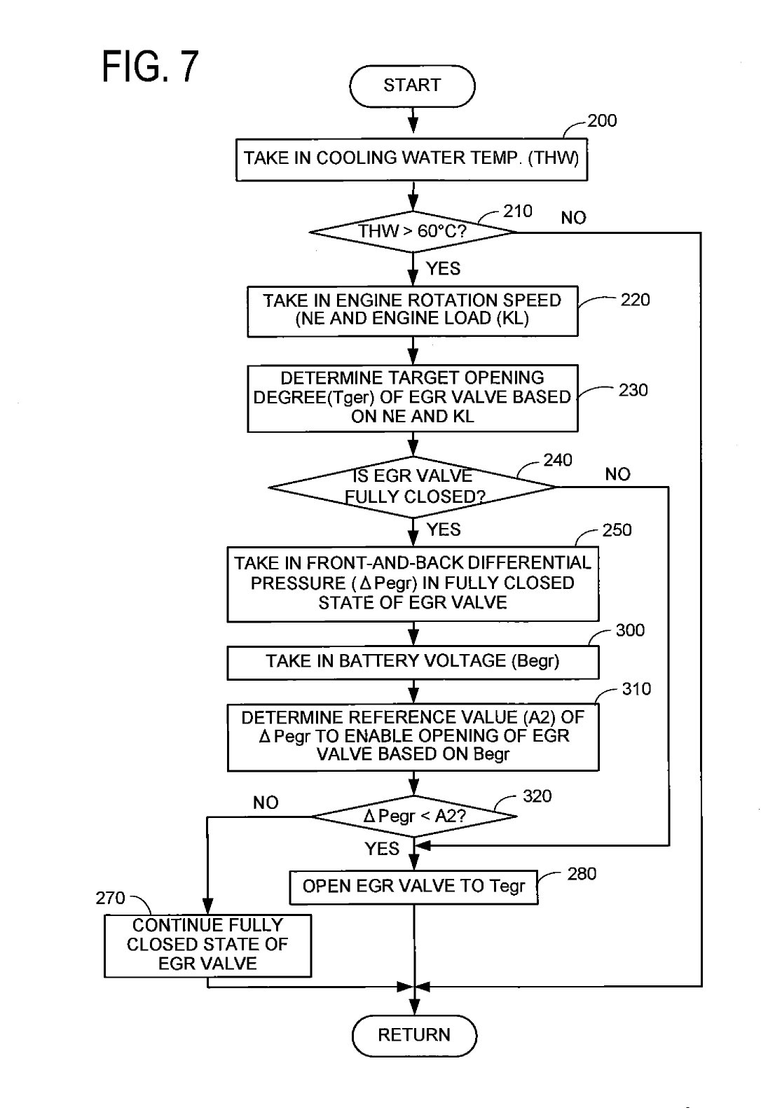

The flowchart in FIG. 7 is different from the flowchart in FIG. 4 in the processing details in Steps 300, 310, and 320. The processing details in the remaining Steps 200 to 250, 270, and 280 in FIG. 7 are the same as those in the flowchart in FIG. 4.

As shown in FIG. 7, in Step 300 following Step 250, the ECU 50 takes in a voltage (battery voltage) Begr of the battery 30.

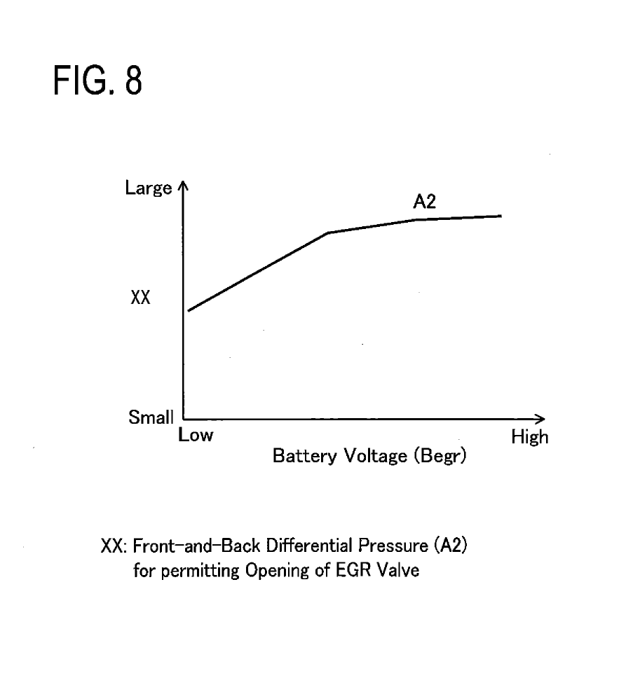

In Step 310, subsequently, the ECU 50 determines a reference value A2 of the front-and-back differential pressure ΔPegr to allow opening of the EGR valve 18 from the fully closed state based on the battery voltage Begr. For instance, the ECU 50 can obtain this reference value A2 by referring to the map set in advance as shown in FIG. 8. This map is set so that, as the battery voltage Begr becomes higher, the reference value A2 becomes larger in a curve.

In Step 320, the ECU 50 then judges whether or not the front-and-back differential pressure ΔPegr is smaller than the calculated reference value A2. If NO in Step 320, the ECU 50 shifts the processing to Step 270. If YES in Step 320, the ECU 50 shifts the processing to Step 280.

In the present embodiment, therefore, in the processing of the EGR valve opening control routine, the reference value A2 of the front-and-back differential pressure ΔPegr is corrected according to the battery voltage Begr of the battery 30. Accordingly, the drive force required to the step motor 34 is changed according to changes in battery voltage Begr. For instance, when the battery voltage Begr becomes relatively lower, the reference value A2 is corrected to be relatively smaller. Thus, in the presence of an opening request to the EGR valve 18, the step motor 34 is driven with a smaller drive force against the smaller front-and-back differential pressure ΔPegr, thereby driving the valve element 33, so that the EGR valve 18 is opened from the fully closed state. In addition to the operations and effects in the first embodiment, therefore, in case the battery voltage Begr lowers, the EGR valve 18 is allowed to open from the fully closed state and opening of the EGR valve 18 is ensured.

### Third Embodiment

A third embodiment of an exhaust gas recirculation for an engine according to the invention will be described below referring to the accompanied drawings.

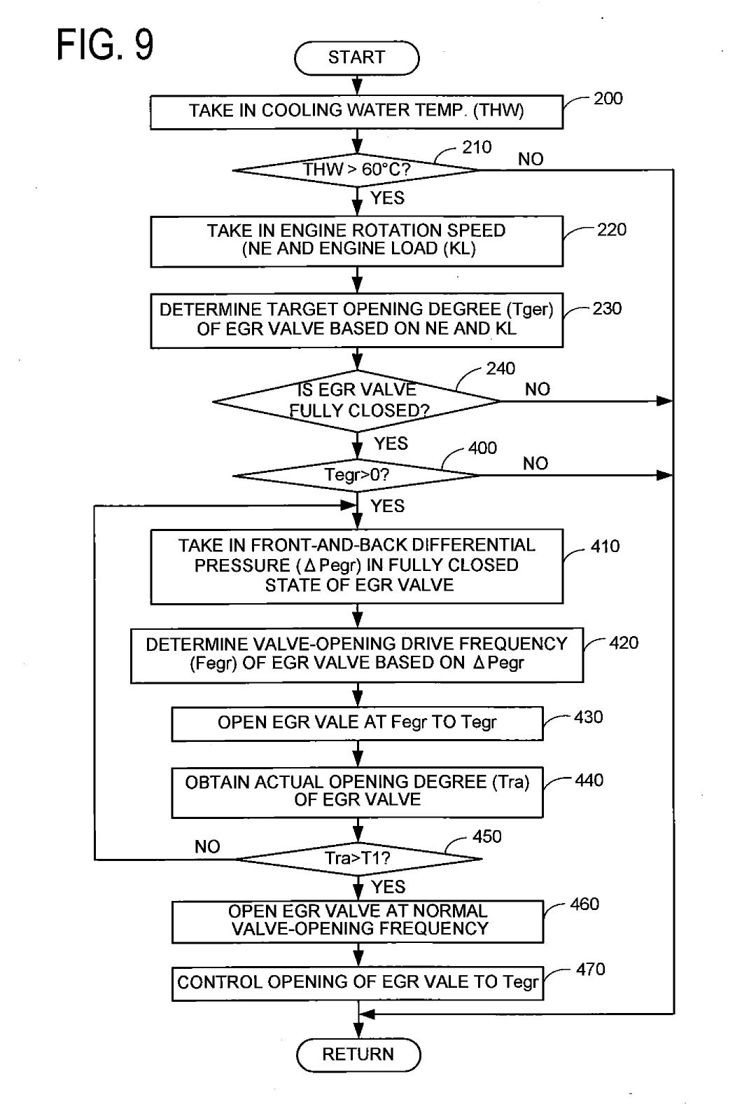

This third embodiment differs from the first and second embodiments in the processing details of the EGR valve opening control routine. FIG. 9 is a flowchart showing one example of the processing details of the EGR valve opening control routine to be executed by the ECU 50. In the third embodiment, the ECU 50 is one example of an energization control unit.

The flowchart in FIG. 9 is different from the flowchart in FIG. 4 in the processing details in Steps 400 to 460. The processing details in the remaining Steps 200 to 240 in FIG. 9 are the same as those in the flowchart in FIG. 4.

As shown in FIG. 9, in Step 400 following Step 240, the ECU 50 judges whether or not the target opening degree Tegr of the EGR valve 18 is larger than “0”. Specifically, the ECU 50 judges whether or not a request to open the EGR valve 18 is present. If NO in Step 240, the ECU 50 returns the processing to Step 200. If YES in Step 240, the ECU 50 shifts the processing to Step 410.

In Step 410, the ECU 50 takes in the front-and-back differential pressure ΔPegr of the EGR valve 18 in the fully closed state.

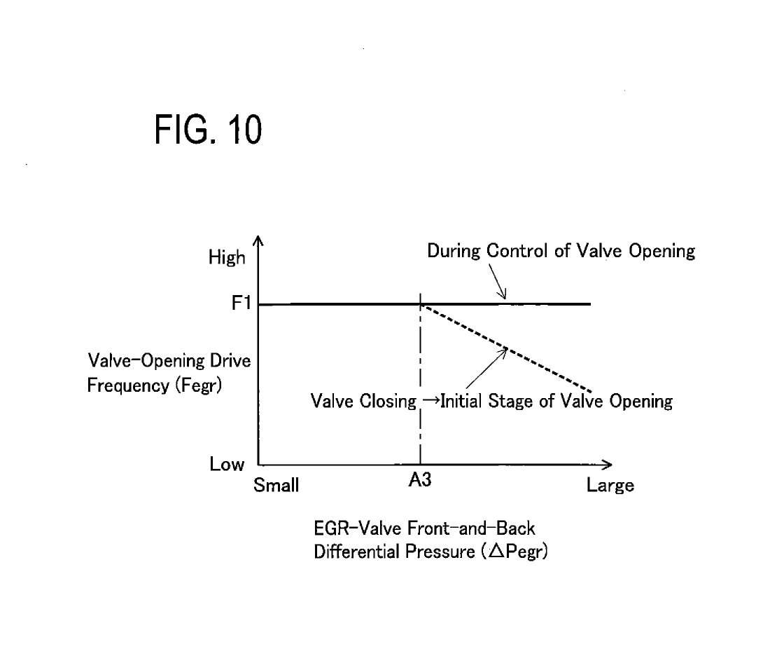

In Step 420, the ECU 50 determines a valve-opening drive frequency Fegr of the EGR valve 18 based on the calculated front-and-back differential pressure ΔPegr. This valve-opening drive frequency Fegr is a special drive frequency to open the EGR valve 18 from the fully closed state and is set at a frequency lower than a normal valve-opening drive frequency. The ECU 50 can obtain this valve-opening drive frequency Fegr by referring to a map previously set as shown in FIG. 10. In this map, during valve-opening control of the EGR valve 18, the valve-opening drive frequency Fegr is a constant value F1 irrespective of the magnitude of the front-and-back differential pressure ΔPegr. In contrast, at the initial stage where the EGR valve 18 is opened from the fully closed state, the valve-opening drive frequency Fegr is set to become linearly lower as the front-and-back differential pressure ΔPegr is larger than a predetermined reference value A3.

Herein, the valve-opening drive frequency Fegr of the step motor 34 means the time in which energization of the coil 41 of the stator is maintained to move the magnet rotor 42 of the step motor 34 in a rotation direction. This indicates that, assuming that the normal valve-opening drive frequency is for example “250 (PPS)”, an energization time of the coil 41 at each Step is “ 1/250 (seconds)”. If the valve-opening drive frequency Fegr is too high, the time to move and hold the magnet rotor 42 by the magnetic force of the coil 41 becomes short. Thus, the rotation of the magnet rotor 42 cannot follow the valve-opening drive frequency. In contrast, if the valve-opening drive frequency is low, the time to move and hold the magnet rotor 42 by the magnetic force of the coil 41 becomes long. This causes less loss of synchronization and increases output torque of the step motor 34.

In Step 430, the ECU 50 opens the EGR valve 18 at the determined valve-opening drive frequency Fegr to the target opening degree Tegr.

In Step 440, the ECU 50 then obtains an actual opening degree of the EGR valve 18. The ECU 50 can obtain this actual opening degree Tra from a command value (the number of motor steps Mst(n)) to the step motor 34 of the EGR valve 18.

In Step 450, thereafter, the ECU 50 judges whether or not the actual opening degree Tra is larger than a predetermined reference value T1. This reference value T1 may be set to for example “3%”. If NO in Step 450, the ECU 50 returns the processing to Step 410 and then repeats the processing in Steps 410 to 450. In other words, if the actual opening degree Tra of the EGR valve 18 does not meet the reference value T1, the ECU 50 opens the EGR valve 18 from the fully closed state based on the valve-opening drive frequency Fegr corresponding to the front-and-back differential pressure ΔPegr.

On the other hand, if YES in Step 450, the ECU 50 opens the EGR valve 180 at the normal valve-opening drive frequency Fegr in Step 460 and controls the EGR valve 18 to the target opening degree Tegr in Step 470, and then returns the processing to Step 200.

According to the above EGR valve opening control routine, when the front-and-back differential pressure ΔPegr is larger than the predetermined reference value A3, the ECU 50 controls to energize the step motor 34 at the valve-opening drive frequency Fegr lower than a normal value at the initial stage to open the EGR valve 18 from the fully closed state.

In the present embodiment, accordingly, when the front-and-back differential pressure ΔPegr is larger than the predetermined reference value A3, the step motor 34 is controlled to be energized at the valve-opening drive frequency Fegr lower than the normal value (e.g., “250 (PPS)”), so that the drive force of the step motor 34 is larger than a normal value. Thus, the EGR valve 18 is opened from the fully closed state with a large drive force. Therefore, the step motor 34 of the conventional type can be used without increasing the size and the performance in accordance with a request of the large drive force to the step motor 34. It is therefore possible to prevent deterioration in mountability of the EGR valve 18 on a vehicle and cost increase of the EGR apparatus.

### Fourth Embodiment

A fourth embodiment of an exhaust gas recirculation for an engine according to the invention will be described below referring to the accompanied drawings.

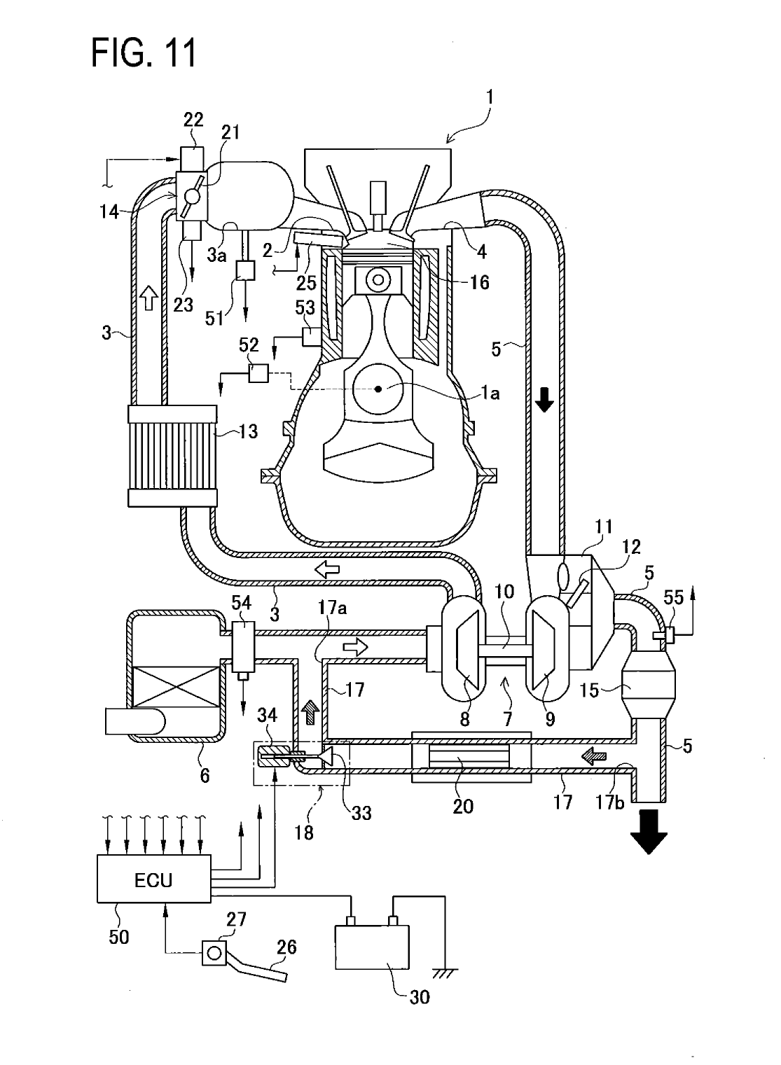

FIG. 11 is a schematic configuration view showing a supercharger-equipped engine system including the EGR apparatus in the fourth embodiment. This fourth embodiment differs from the first and second embodiments in the placement of the EGR apparatus as shown in FIG. 11. In the present embodiment, specifically, the EGR passage 17 is arranged so that the inlet 17b is connected to the exhaust passage 5 downstream from the catalytic converter 15 and the outlet 17a is connected to the intake passage 3 upstream from the compressor 8 of the supercharger 7. The remaining structure is identical to those in each of the aforementioned embodiments.

According to the present embodiment, consequently, during operation of the engine 1 and during activation of the supercharger 7, when the EGR valve 18 is being open, a negative pressure resulting from a supercharged intake pressure acts on the outlet 17a of the EGR passage 17, in the intake passage 3 upstream from the compressor 8, thereby sucking part of exhaust gas flowing in the exhaust passage 5 downstream from the catalytic converter 15, into the intake passage 3 via the EGR passage 17, the EGR cooler 20, and the EGR valve 18. Herein, even in a high supercharge region, the exhaust pressure is reduced to some extent on the downstream side of the catalytic converter 15 serving as a resistance. Accordingly, up to the high supercharge region, the negative pressure resulting from the supercharged intake pressure is caused to act on the EGR passage 17 to perform EGR. Since part of exhaust gas cleaned by the catalytic converter 15 is introduced in the EGR passage 17, the EGR catalytic converter 19 may be removed from the EGR passage 17 as compared with the first embodiment. The other operations and effects in the present embodiment are the same as those in each of the aforementioned embodiments.

The present invention may be embodied in other specific forms without departing from the essential characteristics thereof.

Each of the above embodiments embodies the EGR apparatus of the invention as the engine 1 provided with the supercharger 7. Alternatively, the EGR apparatus of the invention may be applied to an engine provided with no supercharger.

The first and second embodiments use the step motor 34 as an actuator constituting the EGR valve 18. As an alternative, a DC motor other than the step motor may be used.

In the third embodiment, the step motor 34 is controlled to be energized at the valve-opening drive frequency Fegr lower than the normal value at the initial stage to open the EGR valve 18 from the fully closed state. As an alternative, the step motor may be controlled to be energized at the valve-opening drive frequency lower than the normal value not only at the initial stage of valve opening but also throughout the entire period of valve opening.

### INDUSTRIAL APPLICABILITY

The invention is applicable to a gasoline engine or diesel engine for vehicles.

### REFERENCE SINGS LIST

1 Engine
3 Intake passage
3a Surge tank
5 Exhaust passage
16 Combustion chamber
17 EGR passage
18 EGR valve
30 Battery
32 Valve seat
33 Valve element
34 Step motor
50 ECU
51 Intake pressure sensor
54 Air flow meter
A1 Reference value
A2 Reference value
A3 Reference value

1. An exhaust gas recirculation apparatus including:
an exhaust gas recirculation passage to allow part of exhaust gas discharged from a combustion chamber of an engine to an exhaust passage to flow in an intake passage and recirculate back to the combustion chamber; and
an exhaust gas recirculation valve provided in the exhaust gas recirculation passage to regulate an exhaust flow rate in the exhaust gas recirculation passage,
the exhaust gas recirculation valve including a valve seat, a valve element provided to be seatable on the valve seat, and an actuator to drive the valve element,
wherein the apparatus further includes:
a front-side pressure detection unit to detect pressure of exhaust gas on an upstream side of the valve element as a front-side pressure when the exhaust gas recirculation valve is in a fully closed state in which the valve element is seated on the valve seat;
a back-side pressure detection unit to detect pressure of exhaust gas on a downstream side of the valve element as a back-side pressure when the exhaust gas recirculation valve is in the fully closed state; and
a valve-opening control unit configured to calculate a differential pressure between the front-side pressure and the back-side pressure as a front-and-back differential pressure, and allow opening of the exhaust gas recirculation valve from the fully closed state and allow driving of the actuator when the front-and-back differential pressure is smaller than a predetermined reference value.

2. The exhaust gas recirculation apparatus according to claim 1, further including a battery to supply power to the actuator to drive the valve element,
wherein the valve-opening control unit is configured to correct the reference value according to voltage of the battery.

3. An exhaust gas recirculation apparatus including:
an exhaust gas recirculation passage to allow part of exhaust gas discharged from a combustion chamber of an engine to an exhaust passage to flow in an intake passage and recirculate back to the combustion chamber; and
an exhaust gas recirculation valve provided in the exhaust gas recirculation passage to regulate an exhaust flow rate in the exhaust gas recirculation passage,
the exhaust gas recirculation valve including a valve seat, a valve element provided to be seatable on the valve seat, and a step motor to drive the valve element,
wherein the apparatus further includes:
an energization control unit configured to control and energize the step motor at a predetermined drive frequency to open the exhaust gas recirculation valve;
a front-side pressure detection unit to detect pressure of exhaust gas on an upstream side of the valve element as a front-side pressure when the exhaust gas recirculation valve is in a fully closed state in which the valve element is seated on the valve seat; and
a back-side pressure detection unit to detect pressure of exhaust gas on a downstream side of the valve element as a back-side pressure when the exhaust gas recirculation valve is in the fully closed state;
wherein the energization control unit is configured to calculate a differential pressure between the front-side pressure and the back-side pressure as a front-and-back differential pressure and control to energize the step motor at a drive frequency lower than a normal value in at least an initial stage to open the exhaust gas recirculation valve from the fully closed state when the front-and-back differential pressure is larger than a predetermined reference value.
